(19) United States
(12) Patent Application Publication
(10) Pub. No.: US 2012/0149343 A1
(43) Pub. Date: Jun. 14, 2012

(54) SYSTEM AND METHOD FOR STAGING A MOBILE DEVICE THROUGH A VOICE STAGING SERVER

(75) Inventors: Avinash Sanka, Bangalore (IN); Allan Herrod, Mission Viejo, CA (US); Subramani Jagadeesan, Bangalore (IN)

(73) Assignee: Symbol Technologies, Inc., Schaumburg, IL (US)

(21) Appl. No.: 12/967,259

(22) Filed: Dec. 14, 2010

(51) Int. Cl. H04M 11/10

(52) U.S. Cl. 455/413

(57) ABSTRACT

A system for staging a mobile device is described. The system includes a mobility services platform (MSP) server for generating a staging profile. A voice staging server is coupled to the MSP server through a network. The voice staging server selects the staging profile. The mobile device is configured to connect to the voice staging server. The voice staging server transmits audio data representing the staging profile to the mobile device. The mobile device decodes the audio data to apply the staging profile to the mobile device.

### TECHNICAL FIELD

The invention relates generally to staging a mobile device for use on a network.

### BACKGROUND

In order for an electronic device to properly connect to a network, the device has to initially be configured to be managed and be discovered on the management system. Specifically, the device has to be staged that enables the configuration of the device. Staging is the process of quickly preparing mobile devices to deploy into an enterprise by providing settings to configure connectivity to the enterprise network, to configure access to a deployment server, and to specify the deployment to be performed.

### SUMMARY

In one aspect, the invention is embodied in a system for staging a mobile device. The system includes a mobility services platform (MSP) server for generating a staging profile. A voice staging server is coupled to the MSP server through a network. The voice staging server selects the staging profile. A mobile device is configured to communicate with the voice staging server. The voice staging server transmits audio data representing the staging profile to the mobile device over voice call. The mobile device decodes the audio data to apply the staging profile to the mobile device.

In one embodiment, the system also includes a database for storing the staging profile. An administrator can be coupled the voice staging server. The administrator determines whether the mobile device is authorized to receive the staging profile. In one embodiment, the voice staging server can include the administrator functionality. The mobile device can include a voice application configured to communicate with the voice staging server. The voice staging server can authenticate the mobile device prior to transmitting the audio data to the mobile device.

The mobile device can also include a cellular radio for communicating with the voice staging server. The mobile device can also include a receiver for receiving a broadcasted radio-frequency (RF) signal. The mobile device can also include a microphone for receiving an acoustic signal.

The MSP server can generate a plurality of staging profiles. A user of the mobile device can select one of the plurality of staging profiles for staging the mobile device. In one embodiment, the mobile device requests a staging profile from the voice staging server prior to receiving the audio data from the voice staging server.

In another aspect, the invention is embodied in a voice staging server. The voice staging server includes a processor. A memory stores a plurality of staging profiles. A transceiver is configured to communicate with a mobile device. The transceiver receives a selection of one of the plurality of staging profiles from the mobile device. The processor converts the selected staging profile into audio data that is transmitted to the mobile device.

In one embodiment, the voice staging server also includes voice recognition software executing on the processor. The voice recognition software interprets audio signals from the mobile device. The voice staging server can authenticate the mobile device prior to transmitting the audio data to the mobile device. In one embodiment, the voice staging server transmits an audio prompt representing a step required to stage the mobile device.

In one embodiment, a mobility services platform (MSP) server coupled to the voice staging server generates the plurality of staging profiles. A user of the mobile device selects one of the plurality of staging profiles from the voice staging server for staging the mobile device.

In yet another aspect, the invention is embodied in a mobile device. The mobile device includes a processor and a memory. A transceiver is configured to communicate with a voice staging server. The transceiver transmits a selection of one of a plurality of staging profiles. The transceiver further receives audio data representing the selection. The processor decodes the audio data to apply the staging profile.

In one embodiment, the memory stores a voice application for execution on the processor. The transceiver can be configured to connect to a cellular network. In one embodiment, the mobile device requests a staging profile from the voice staging server prior to receiving the audio data from the voice staging server.

The voice staging server can transmit an audio prompt representing a step required to stage the mobile device. The mobile device can include a battery for powering the mobile device. A display can be integrated with the mobile device for displaying information relating to the mobile device.

### BRIEF DESCRIPTION OF THE FIGURES

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

The above and further advantages of this invention may be better understood by referring to the following description in conjunction with the accompanying drawings, in which like numerals indicate like structural elements and features in various figures. Skilled artisans will appreciate that reference designators shown herein in parenthesis indicate components shown in a figure other than the one in discussion. For example, talking about a device (10) while discussing Figure A would refer to an element, 10, shown in figure other than Figure A.

FIG. 1 illustrates a network configured for voice staging of a mobile device according to an exemplary embodiment.

FIG. 2 is a block diagram illustrating the electronic components of the voice staging server of FIG. 1 according to an exemplary embodiment.

FIG. 3 illustrates a method for voice staging a mobile device for a network according to an exemplary embodiment.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description. For the purposes of conciseness, many conventional techniques and principles related to conventional staging, need not, and are not, described in detail herein.

For example, one conventional approach for staging is using short message service (SMS) messages. In SMS staging, a services platform converts a selected staging profile into a sequence of encrypted SMS messages to the electronic device using one or more carriers. The SMS messages may be delivered to devices via email to SMS gateways provided by the carriers and/or via short message peer-to-peer protocol (SMPP) gateways contracted for with the carriers.

However, with SMS staging, a variety issues may arise. First, information about the device such as a phone number, equipment identification, carrier, etc. is required by an administrator in advance to enable the delivery of a staging profile. Second, depending on the method used to deliver the SMS messages, the messages may be delivered slowly or delayed (e.g., high traffic relegates SMS messages) resulting in a long time for a device to be staged. Third, some methods supported by carriers that deliver SMS messages may be limited. Fourth, depending on the service plan and delivery method, carrier may charge for the delivery of SMS messages to devices.

Techniques and technologies may be described herein in terms of functional and/or logical block components and various processing steps. It should be appreciated that such block components may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The following description may refer to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. The term “exemplary” is used in the sense of “example, instance, or illustration” rather than “model,” or “deserving imitation.”

Technologies and concepts discussed herein relate to systems and methods of staging mobile devices. In an exemplary embodiment, a system for staging a mobile device includes a mobility services platform (MSP) server for generating a staging profile. A voice staging server is coupled to the MSP server for selecting the staging profile. The mobile device is configured to connect to the voice staging server to receive audio data representing the staging profile. The mobile device decodes the audio data to apply the staging profile to the mobile device.

The exemplary embodiments describe a voice staging of a mobile device. Specifically, a voice staging server is configured to provide staging profile data to the mobile device for the staging thereof. The voice staging, the mobile device, the voice staging server, a network to which the mobile device is staged, and a related method will be discussed in further detail below.

It should be noted that the mobile device being staged is only exemplary. The exemplary embodiments may be used for any electronic device that is configured with a voice application. For example, the electronic device may be a terminal with a telephone application. Thus, the mobile device as described herein may refer to both mobile electronic devices and stationary electronic devices.

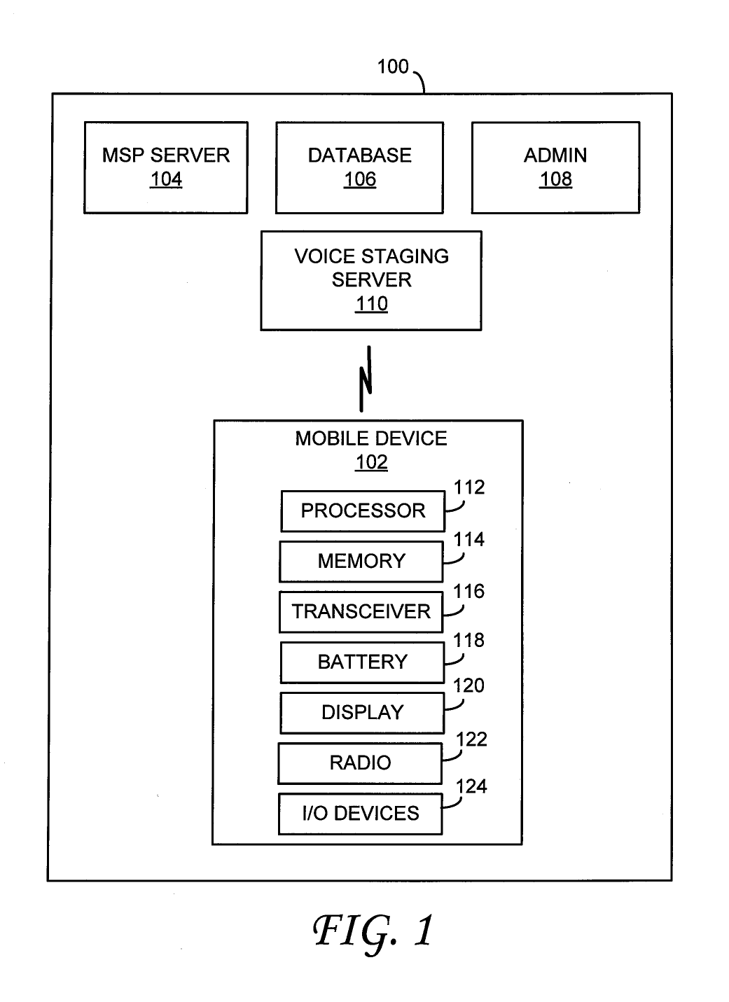

FIG. 1 shows a network 100 configured for voice staging of a mobile device 102 according to an exemplary embodiment. The network 100 may be any conventional type of network. For example, the network 100 may be a local area network (LAN), a wireless LAN (WLAN), a virtual LAN (VLAN), a wide area network (WAN), a wireless WAN (WWAN), a virtual WAN (VWAN), a metropolitan area network (MAN), a storage area network (SAN), etc. The network 100 may be configured to support data and voice applications such as Internet capabilities, SMS messages, a telephone functionality, etc. The network 100 may include a variety of network components providing conventional functionalities. As illustrated in the exemplary embodiment, the network may include at least a mobility services platform (MSP) server 104, a database 106, and an MSP administrator 108.

The mobile device 102 can include a processor 112 and a memory 114 for storing software applications for execution on the processor 112. The memory 114 can also store information relating to the mobile device such as one or more staging profiles. The mobile device 102 can also include a transceiver 116. The transceiver 116 is configured to connect the mobile device 102 to the network 100 following voice staging of the mobile device 102 according to the invention. The mobile device 102 can include a voice application for execution on the processor 112. The voice application decodes audio data representing the staging profile and applies the staging profile to the mobile device 102. The mobile device 102 can also include a battery 118 for powering the mobile device 102 and a display 120 for displaying information relating to the mobile device 102.

The mobile device 102 can also include a radio 122, such as a cellular radio which allows the mobile device to communicate with the voice staging server 110 prior to staging. In one embodiment, the radio 122 can also include an RF radio that can receive a broadcasted radio-frequency (RF) signal. The mobile device 102 can also include input/output (I/O) devices 124 including a keypad, touch screen, joystick, one or more control switches, a microphone, and/or any other suitable device that allows a user to interact with the mobile device 102.

The MSP server 104 is the central management system that coordinates staging for all devices in the network 100 and ultimately manages all the devices following staging. Thus, MSP server 104 may be configured to provide the conventional manner of staging using the SMS messages over the network 100. As will be discussed in further detail below, the MSP server 104 may also generate staging profiles used to stage mobile devices. The database 106 may store data for the network 100. For example, the database 106 may store the various staging profiles, identification and authentication data for electronic devices of the network 100, and other network data. The MSP administrator 108 may determine permission for data exchange such as controlling which end devices are allowed to receive or transmit data on the network 100. Furthermore, the MSP administrator 108 may restrict whether the mobile device 102 is authorized to receive a particular staging profile.

A voice staging server 110 may be configured to perform conventional voice server functionalities. According to the exemplary embodiments, the mobile device 102 can transmit a staging request to the voice staging server 110 via an audio call. The voice staging server 110 is configured to receive the audio request from the mobile device 102 for staging and subsequently send a selected staging profile to the mobile device 102. As discussed above, the staging profile may be stored in the database 106. Thus, the voice staging server 110 may retrieve the staging profile from the database 106. It should also be noted that the voice staging server 110 may be configured with a storage unit that stores the various staging profiles. In one embodiment, the voice staging server 110 delivers audio prompts to the mobile device 102. The user of the mobile device 102 listens to the audio prompts and performs any required authentication (e.g., by sending touch-tone (DTMF) key presses via the mobile device 102 to the voice staging server 110 or by speaking the digits into the mobile device 102).

In a first example, the mobile device 102 may be a new wireless mobile device. Thus, the mobile device 102 may not be properly configured to connect to any network such as the network 100 which may be an enterprise network. In another example, the mobile device 102 may be configured to connect to other networks but not configured to connect to the network 100. Thus, to properly be configured, the mobile device 102 is required to be staged.

As illustrated in FIG. 1, the mobile device 102 may be disposed within an operating area of the network 100. Specifically, the mobile device 102 may be in communication with the voice staging server 110 directly or indirectly through at least one other network component (e.g., an access point, a router, etc.). It should be noted that the operating area of the network 100 is only exemplary. Those skilled in the art will understand that there are various network topologies in which the mobile device 102 may be capable of connecting to the voice staging server 110.

The voice staging server 110 may be configured as an initial access point for the mobile device 102. Specifically, according to the exemplary embodiments, because the mobile device 102 requires staging, the voice staging server 110 may be the initial component of the network 100 for which a mobile device is to be associated. Furthermore, those skilled in the art will understand that the mobile device 102 can be equipped with a voice application including telephone functionality that is configured to communicate with the voice staging server 110. The voice application can also include other functionality, such as voice recognition functionality.

To connect with the voice staging server 110, a new mobile device 102 can be have an appropriate voice application pre-installed. Thus, if the mobile device 102 is a new device, the user may need to establish phone service. If the mobile device 102 is configured with a subscriber identity module (SIM) card, the phone service may be established simply from inserting the SIM card from a carrier into the mobile device 102. If the mobile device 102 is not configured with a SIM card, the user may be required to interact with a carrier and/or provide manual entry of carrier-supplied information. Once the mobile device 102 has phone service, the user may launch a voice staging application installed on the mobile device 102.

Upon connection with the voice staging server 110, the mobile device 102 may receive a series of inputs such as a telephone number that is related to the voice staging server 110. Thus, upon launching, the voice staging application executing on the mobile device 102 may offer to dial a built-in phone number associated with the voice staging server 110. It should be noted that the user may decline the offer to dial a predetermined phone number associated with a different voice staging server to stage to a different enterprise and be configured therewith.

Once the mobile device 102 has connected to the voice staging server 110, the voice staging server 110 may automatically walk the user through the staging process. For example, the voice staging server 110 may interact with the user with generated-voice prompts and use audio replies from the user (e.g., spoken replies received and interpreted with voice recognition software, dual-tone multi-frequency (DTMF) signaling and/or touch-tone key presses, etc.).

Upon receiving the audio replies from the user, the voice staging server 110 may determine a staging profile for the mobile device 102. A staging profile may be used to encapsulate everything to be performed during staging including all configurations to be applied to devices and all deployment to be performed by devices. As discussed above, the staging profiles may be stored in the database 110. Thus, the voice staging server 110 may retrieve the staging profile generated by the MSP server 104, thereby becoming available to the mobile device 102 via the voice staging application.

According to an exemplary embodiment, prior to any communication of prompts and receiving of replies relating to the staging profile, the voice staging server 110 may initially authenticate the user and/or the mobile device 102. The voice staging server 110 may transmit voice prompts related to authentication. The user may provide replies (e.g., spoken replies, DTMF signaling, etc.) in response to the authentication prompts. For example, the authentication prompts may relate to an account number, a password, user specific details, mobile device identity, etc. The voice staging server 110 may verify the replies received from the mobile device 102 with data available on the MSP administrator 108. In one embodiment, the voice staging server 110 can include the MSP administrator 108.

According to a further exemplary embodiment, the use of the voice staging server 110 to stage the mobile device 102 may be available to users based upon entitlement. Entitled users may log into the voice staging server 110 from a workstation or any device with transceiving functionality via the Internet to manage the user-specific set of staging profiles that are available and generated by the MSP server 104. If a user elects to host a personal voice staging server, the user may manage the staging profiles and/or control through authentication to access the staging profiles in a substantially similar manner.

According to yet another exemplary embodiment, the authentication process may be mandatory, especially when the user is required to establish entitlement and ensure controlled access to the staging profiles. Authentication may be optional, especially for a personal voice staging server.

As discussed above, upon authentication, the voice staging server 110 may receive the replies to the voice staging prompts. According to a first exemplary embodiment, the voice staging server 110 may determine the appropriate staging profile and automatically provide the subsequent steps to stage the mobile device 102. According to a second exemplary embodiment, the voice staging server 110 may provide a list of the authorized staging profiles that are available to the user, for example, based upon entitlement. The user may provide an audio reply (e.g., voice recognition, DTMF, etc.) that corresponds to a specific staging profile.

Once a desired staging profile is selected, the voice staging server may repeat (e.g., text to speech) the selected staging profile and request the user to verify the selection. Upon verification, the voice staging server 110 may transmit signals for an audio staging of the mobile device 102 via the voice staging application. The voice staging application of the mobile device 102 may listen for audio staging over the voice call. The voice staging server 110 may transmit the selected staging profile by converting the data into audio signals and playing it over the voice call. Upon reception of the audio signals, the voice staging application of the mobile device 102 may decode the received audio into the selected staging profile and apply the staging profile to the mobile device 102.

In one embodiment, a user operating a workstation personal computer connected to the network can communicate with the voice staging server via a data network interface (e.g. internet and web browser). The user can pre-stage the mobile device by authenticating a mobile device, selecting a staging profile, etc., via the computer. The voice staging server can then produce the staging profile as an audio file and transmit the audio file to the computer. The audio file can be formatted as a MP3 file, for example. The computer can “play” the audio file through its speakers. One or more mobile devices can be positioned near the speakers and can “hear” the staging profile being played, using their integrated microphones. Each mobile device would be placed into “listen mode” in order to “hear” the staging profile.

Thus, the same voice staging server can be used to stage multiple mobile devices from a single computer without the need to make multiple cellular calls to the voice staging server and without the need to perform the authentication and selection processes multiple times (once for each mobile device).

In another embodiment, a user operating a workstation personal computer connected to the network can communicate with the voice staging server via a data network interface (e.g. internet and web browser). The user can pre-stage the mobile device by authenticating a mobile device, selecting the staging profile, etc., via the computer. The voice staging server can then produce the staging profile as an audio file and transmit the audio file to the computer.

The computer can include an AM or a FM transmitter that can broadcast the audio file having the staging profile over a radio-frequency (RF) band. One or more mobile devices having AM/FM receivers can be positioned within “range” of the broadcast and can “hear” the staging profile being played. Each mobile device would be placed into “listen mode” in order to “hear” the staging profile.

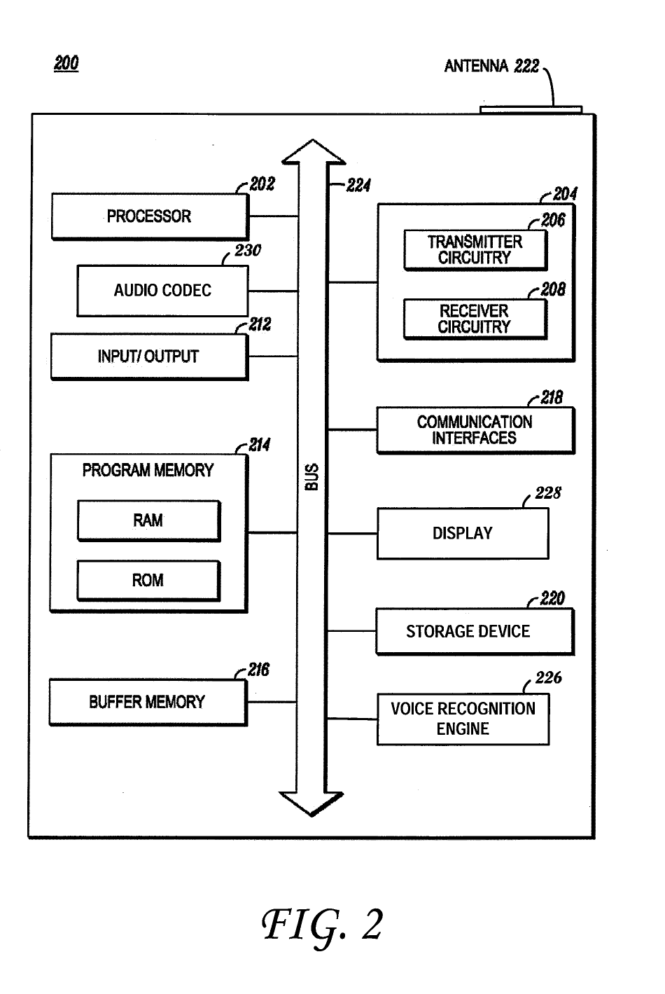

FIG. 2 is a block diagram 200 illustrating the electronic components of the voice staging server 110 (FIG. 1) according to the invention. The voice staging server 110 contains, among other components, a processor 202, I/O devices 212, a program memory 214 for storing operating instructions that are executed by the processor 202, a buffer memory 216, one or more communication interfaces 218, and a transceiver 226 for communicating over a network. The voice staging server 110 can also include an optional display 228 for displaying information and data. The transceiver 204 can include transmitter circuitry 206 and receiver circuitry 208. The voice staging server 110 can also include a voice recognition engine 228 that can be implemented in software executing on the processor 202. The voice staging server 110 can also include an optional audio codec 230. In one embodiment, the functions of the optional audio codec 230 can be implemented in the processor 202.

The voice staging server 110 is preferably an integrated unit containing the elements depicted in FIG. 2, as well as any other element necessary for the voice staging server 110 to function. In one embodiment, the electronic components are connected by a bus 224.

The processor 202 can include one or more microprocessors, microcontrollers, DSPs, state machines, logic circuitry, analog to digital (A/D) converters, hardware digitizers, or any other device or devices that process information based on operational or programming instructions. Such operational or programming instructions are preferably stored in the program memory 214. The program memory 214 can be an IC memory chip containing any form of random access memory (RAM) or read only memory (ROM), a floppy disk, a compact disk (CD) ROM, a hard disk drive, a digital video disk (DVD), a flash memory card or any other medium for storing digital information. Skilled artisans will recognize that when the processor 202 has one or more of its functions performed by a state machine or logic circuitry, the program memory 214 containing the corresponding operational instructions may be embedded within the state machine or logic circuitry. Operations performed by the processor 202 as well as the voice staging server 110 are described in detail below.

The optional transmitter circuitry 206 and the optional receiver circuitry 208 enable the voice staging server 110 to respectively transmit and receive communication signals. In this regard, the transmitter circuitry 206 and the receiver circuitry 208 can include circuitry to enable wireless transmissions. The implementations of the transmitter circuitry 206 and the receiver circuitry 208 depend on the implementation of the voice staging server 110 and the devices with which it is to communicate. For example, the transmitter 206 and receiver circuitry 208 can be implemented as part of the communication device hardware and software architecture in accordance with known techniques. One of ordinary skill in the art will recognize that most, if not all, of the functions of the transmitter 206 or receiver circuitry 208 can be implemented in a processor, such as the processor 202. However, the processor 202, the transmitter circuitry 206, and the receiver circuitry 208 have been partitioned herein to facilitate a better understanding of the functions of these elements. In one embodiment, the voice staging server 110 can include an antenna 222, such as a local area network (LAN) antenna coupled to the transceiver 204.

The buffer memory 216 may be any form of volatile memory, such as RAM, and is used for temporarily storing information received from the MSP server 104 and/or mobile device 102 (FIG. 1), for example. The voice staging server 110 can also include a storage device 220. The storage device 220 can be a hard disk drive, for example. The storage device 220 can store software applications and/or data. For example, the storage device 220 can include a database for storing a plurality of staging profiles.

The voice recognition engine 226 is controlled by the processor 202. The processor 202 issues commands executed by the voice recognition engine 226 via the program memory 214. In one embodiment, the program memory 214 is implemented within a field programmable gate array (FPGA); however the program memory 214 may also be implemented in other devices.

The voice recognition engine 226 decodes an audio signal from the voice staging application of the mobile device 102 to generate a command recognizable to the processor 202. The voice recognition engine 226 also converts staging profile data to audio data that is transmitted to the mobile device 102. In one embodiment, the voice recognition engine 226 can be implemented in the processor 202.

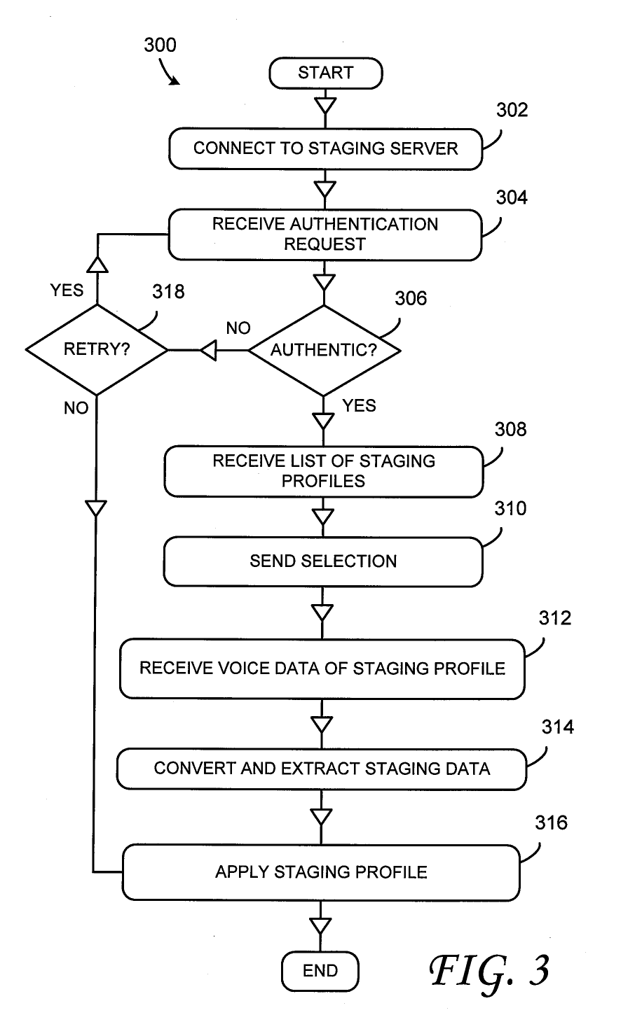

FIG. 3 illustrates a method 300 for voice staging the mobile device 102 (FIG. 1) for a network according to an exemplary embodiment. The method 300 will be described with reference to FIG. 1. The method 300 will also be described according to the mobile device 102 and with reference to the above described exemplary embodiments in which the voice staging includes authentication and entitlement processes. It should be noted that it may be assumed that the mobile device 102 is disposed to directly or indirectly connect to the voice staging server 110.

In step 302, the mobile device 102 connects to the voice staging server 110. As discussed above, the mobile device 102 may be configured with a voice staging application. Thus, a user of the mobile device 102 may initially launch the voice staging application. Also as discussed above, the voice staging application may either automatically dial a built-in phone number to connect to the voice staging server 110 or receive an input from the user of a phone number to connect to a different voice staging server.

In step 304, the mobile device 102 receives an authentication prompt from the voice staging server 110. As discussed above, the authentication prompt may be an initial process upon the mobile device 102 connecting to the voice staging server 110. In step 306, a determination is made whether the authentication process was successful. As discussed above, the voice staging server 110 may access the MSP administrator 108 to verify any replies received from the mobile device 102 relating to the authentication prompts. If the authentication failed, the method 200 continues to step 318. If another attempt to authenticate the mobile device 102 is selected, the method 200 returns to step 304 and receives the authentication request. If no retry is made, the method 300 ends.

In step 308, the mobile device 102 receives a list of staging profiles from the voice staging server 110. As discussed above, the list of staging profiles may be based upon entitlement. Thus, the list includes the available staging profiles for the user and the mobile device 102 as a function of the authentication and/or further staging prompts. In step 310, a user selects one of the staging profiles and sends a reply to the voice staging server 110. As discussed above, any reply to a prompt including the selection for the staging profile may be performed using a variety of methods such as voice recognition, DTMF, etc.

In step 312, the voice staging application of the mobile device 102 receives the voice data of the staging profile. As discussed above, the voice staging server 110 may convert the data of the selected staging profile into audio data that is played over the phone call. In step 314, the voice staging application of the mobile device 102 decodes the audio data to convert the audio data back to the staging profile data. Thus, in step 316, the voice staging application applies the staging profile. Once applied, the mobile device 102 is properly staged and may properly connect to the network 100.

The exemplary embodiments provide a voice staging of a mobile device 102. The voice staging enables a mobile device 102 that is not yet properly staged for the enterprise to initially connect to a voice staging server 110. The mobile device 102 may include a built-in voice staging application that is configured for the voice staging.

The voice staging server 110 may request information relating to the user and/or the mobile device 102 via audio prompts. The user may provide voice inputs and/or DTMF signals as replies to the audio prompts. For example, the prompts and replies may relate to authentication, entitlement, mobile device information, etc. The voice staging server 110 may play a list of staging profiles that are received by the voice staging application of the mobile device. When a selection of the staging profile is sent to the voice staging server 110, the voice staging server 110 may convert the staging profile data into audio data that is received by the voice staging application executing on the mobile device 102. The voice staging application consequently decodes the audio data back to the staging profile data for application on the mobile device 102.

The exemplary embodiments provide for the staging of a mobile device in a simpler, quicker, more reliable, and cost efficient manner. The voice staging allows the user of the mobile device to stay in control of the staging process and may be better able to troubleshoot any issues that may arise.

Those skilled in the art will understand that the above described exemplary embodiments may be implemented in any number of manners, including, as a separate software module, as a combination of hardware and software, etc. For example, the voice staging application of the mobile device 102 and/or the voice staging server 110 may be a program containing lines of code that, when compiled, may be executed on a processor.

In general, the processor can include processing logic configured to carry out the functions, techniques, and processing tasks associated with the operation of the mobile device. Furthermore, the steps of a method or algorithm described in connection with the embodiments disclosed herein may be embodied directly in hardware, in firmware, in a software module executed by the processor, or any combination thereof. Any such software may be implemented as low level instructions (assembly code, machine code, etc.) or as higher-level interpreted or compiled software code (e.g., C, C++, Objective-C, Java, Python, etc.).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus described herein. The non-processor circuits may include, but are not limited to, a radio receiver, a radio transmitter, signal drivers, clock circuits, power source circuits, and user input devices. As such, these functions may be interpreted as steps of a method to perform the mobile device staging described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage element or medium having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While at least one example embodiment has been presented in the foregoing detailed description, it should be appreciated that a vast number of variations exist. It should also be appreciated that the example embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

In addition, the section headings included herein are intended to facilitate a review but are not intended to limit the scope of the present invention. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts or steps is intended to be required unless specifically indicated.

What is claimed is:

1. A system, comprising:
a mobility services platform (MSP) server for generating a staging profile;
a voice staging server coupled to the MSP server, the voice staging server selecting the staging profile; and
a mobile device configured to communicate with the voice staging server, the voice staging server transmitting audio data representing the staging profile to the mobile device, the mobile device decoding the audio data to apply the staging profile to configure the mobile device to be deployed in a network.

2. The system of claim 1, further comprising a database for storing the staging profile.

3. The system of claim 1, further comprising an administrator coupled the voice staging server, the administrator determining whether the mobile device is authorized to receive the staging profile.

4. The system of claim 1, wherein the mobile device comprises a voice application configured to communicate with the voice staging server.

5. The system of claim 1, wherein the voice staging server authenticates the mobile device prior to transmitting the audio data to the mobile device.

6. The system of claim 1, wherein the mobile device comprises a cellular radio for communicating with the voice staging server.

7. The system of claim 1, wherein the mobile device comprises a receiver for receiving a broadcasted radio-frequency (RF) signal.

8. The system of claim 1, wherein the mobile device comprises a microphone for receiving an acoustic signal.

9. The system of claim 1, wherein the MSP server generates a plurality of staging profiles, a user of the mobile device selecting one of the plurality of staging profiles for staging the mobile device.

10. The system of claim 1, wherein the mobile device requests a staging profile from the voice staging server prior to receiving the audio data from the voice staging server.

11. A voice staging server, comprising:
a processor;
a memory storing a plurality of staging profiles; and
a transceiver configured to communicate with a mobile device, wherein the transceiver receives a selection of one of the plurality of staging profiles from the mobile device, the processor converting the selected staging profile into audio data that is transmitted to the mobile device to be configured to be deployed in a network.

12. The voice staging server of claim 11, further comprising voice recognition software executing on the processor, the voice recognition software interpreting audio signals from the mobile device.

13. The voice staging server of claim 11, wherein the voice staging server authenticates the mobile device prior to transmitting the audio data to the mobile device.

14. The voice staging server of claim 11, wherein the voice staging server transmits an audio prompt representing a step required to stage the mobile device.

15. The voice staging server of claim 11, wherein a mobility services platform (MSP) server coupled to the voice staging server generates the plurality of staging profiles, a user of the mobile device selecting one of the plurality of staging profiles from the voice staging server for staging the mobile device.

16. A mobile device, comprising:
a processor;
a memory; and
a transceiver configured to communicate with a voice staging server, the transceiver further transmitting a selection of one of a plurality of staging profiles, the transceiver further receiving audio data representing the selection, the processor decoding the audio data to configure the mobile device to be deployed in a network with the staging profile.

17. The mobile device of claim 16, wherein the memory stores a voice application for execution on the processor.

18. The mobile device of claim 16, wherein the transceiver is configured to connect to a cellular network.

19. The mobile device of claim 16, wherein the mobile device requests a staging profile from the voice staging server prior to receiving the audio data from the voice staging server.

20. The mobile device of claim 16, wherein the voice staging server transmits an audio prompt representing a step required to stage the mobile device.

21. The mobile device of claim 16, further comprising a battery for powering the mobile device.

22. The mobile device of claim 16, further comprising a display for displaying information relating to the mobile device.
